(19) United States
(12) Patent Application Publication
(10) Pub. No.: US 2009/0257473 A1
(43) Pub. Date: Oct. 15, 2009

(54) RFID Fast Hop Frequency Hopping

(75) Inventor: John R. Tuttle, Boulder, CO (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: KEYSTONE TECHNOLOGY SOLUTIONS, LLC, Boise, ID (US)

(21) Appl. No.: 12/103,318

(22) Filed: Apr. 15, 2008

(51) Int. Cl. H04B 1/00; H04Q 5/22

(52) U.S. Cl. 375/132; 375/133; 375/135; 340/10.1; 375/E01.001; 375/E01.033; 375/E01.034

(57) ABSTRACT

Methods and apparatus, including computer program products, for RFID fast hop frequency hopping. A method including transmitting from a radio frequency identification (RFID) interrogator a continuous wave un-modulated radio frequency (RF) signal from a frequency synthesizer based on digital waveform reconstruction with Direct Memory Access (DMA), the continuous wave un-modulated RF signal conforming to a fast hop frequency hopping protocol in which each hop of a plurality of hops spans at least one bit but less than the totality of bits to be sent from a single RFID device data in a single communications session.

### BACKGROUND

The present invention relates to radio frequency identification (RFID), and more particularly to RFID fast hop frequency hopping.

RFID is a technology that incorporates the use of electromagnetic or electrostatic coupling in the radio frequency (RF) portion of the electromagnetic spectrum to uniquely identify an object, animal, or person. With RFID, the electromagnetic or electrostatic coupling in the RF portion of the electromagnetic spectrum is used to transmit signals. A typical RFID system includes an antenna and a transceiver, which reads the radio frequency and transfers the information to a processing device (interrogator) and a transponder, or RF device, which contains the RF circuitry and information to be transmitted. The antenna enables the integrated circuit to transmit its information to the interrogator that converts the radio waves reflected back from the RFID device into digital information that can then be passed on to computers or processors that can analyze the data. The computers or processors can be housed within the interrogator or external to the interrogator. The computers, processors or interrogators can provide control or command information to the RFID devices related to timing, operating methods, start methods, pulse methods, and/or communications protocol selection parameters.

### SUMMARY

The present invention provides methods and apparatus, including computer program products, for RFID fast hop frequency hopping.

In one aspect, the invention features a method including transmitting from a radio frequency identification (RFID) interrogator a continuous wave un-modulated radio frequency (RF) signal from a frequency synthesizer based on digital waveform reconstruction with Direct Memory Access (DMA), the continuous wave un-modulated RF signal conforming to a fast hop frequency hopping protocol in which each hop of a plurality of hops spans at least one bit but less than the totality of bits to be sent from a single RFID device data in a single communications session.

In another aspect, the invention features a method including transmitting from a radio frequency identification (RFID) interrogator a continuous wave un-modulated radio frequency (RF) signal from a frequency synthesizer based on digital waveform reconstruction with a Digital to Analog Converter (DAC), the continuous wave un-modulated RF signal conforming to a fast hop frequency hopping protocol in which each hop of a plurality of hops spans at least one bit but less than the totality of bits to be sent from a single RFID device data in a single communications session.

In another aspect, the invention features a radio frequency identification (RFID) interrogator including a microcontroller coupled to a radio frequency (RF) transmitter and a RF receiver, an antenna coupled to the RF transmitter and RF receiver, and the microcontroller causing the RF transmitter to transmit a continuous wave un-modulated radio frequency (RF) signal from a frequency synthesizer based on digital waveform reconstruction with Direct Memory Access (DMA), the continuous wave un-modulated RF signal conforming to a fast hop frequency hopping protocol in which each hop of a plurality of hops spans at least one bit but less than the totality of bits to be sent from a single RFID device data in a single communications session.

In another aspect, the invention features a radio frequency identification (RFID) interrogator including a microcontroller coupled to a radio frequency (RF) transmitter and a RF receiver, an antenna coupled to the RF transmitter and RF receiver, and the microcontroller causing the RF transmitter to transmit a continuous wave un-modulated radio frequency (RF) signal from a frequency synthesizer based on digital waveform reconstruction with a Digital to Analog Converter (DAC), the continuous wave un-modulated RF signal conforming to a fast hop frequency hopping protocol in which each hop of a plurality of hops spans at least one bit but less than the totality of bits to be sent from a single RFID device data in a single communications session.

### BRIEF DESCRIPTION OF THE DRAWINGS

FIG. 1 is a block diagram of an exemplary radio frequency identification (RFID) system.

FIG. 2 is a block diagram of an exemplary RFID interrogator.

FIG. 3 is an exemplary waveform diagram.

FIG. 4 is an exemplary waveform diagram.

FIG. 5 is an exemplary FDAC implementation of a frequency oscillator.

FIG. 6 is an exemplary waveform.

Like reference numbers and designations in the various drawings indicate like elements.

### DETAILED DESCRIPTION

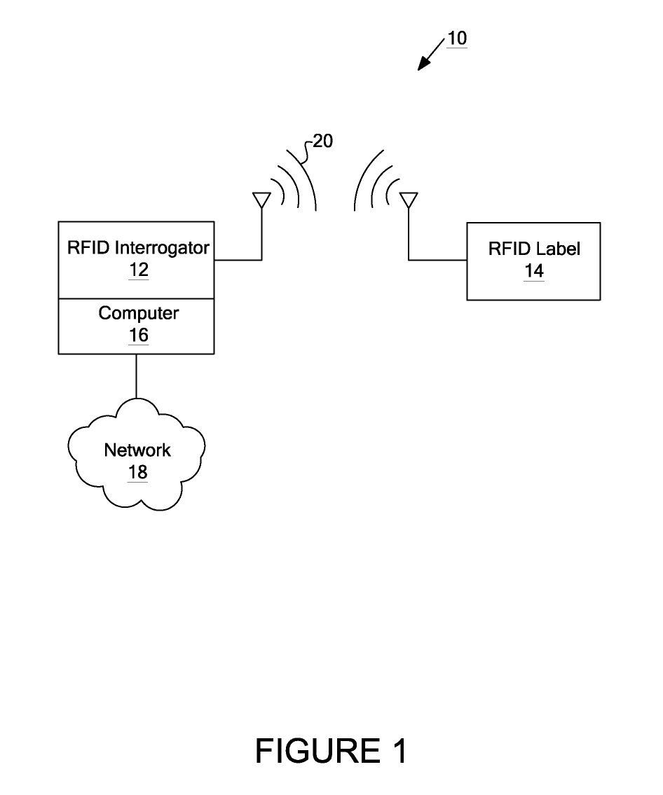

As shown in FIG. 1, an exemplary radio frequency identification (RFID) system 10 includes a RFID interrogator (sometimes referred to as a reader) 12 and a RFID device (sometimes referred to as a tag or label) 14. In this RFID system 10, the RFID interrogator 12 is controlled by a computer 16, whether internal or external, and the computer 16 is coupled to a network 18. In RFID system 10, the RFID device 14 communicates with RFID interrogator 12 using backscatter. More specifically, RFID interrogator 12 sends a radio signal 20 using a frequency protocol sometimes referred to as an “air-interface protocol” that governs the method with which tags and readers communicate. This transmitted unmodulated radio signal is characterized by a frequency and power level. The frequency is usually set to fall within a band of frequencies allowed by regulatory authorities in a given jurisdiction. For example, in the United States, an RFID interrogator operating without a specific license will likely use one of two Industrial, Scientific, and Medical bands allocated by the Federal Communications Commission (FCC), i.e., 902-915 MHz or 2.4-2.485 GHz. In Europe, the RFID interrogator likely will operate within the 865-868 MHz band prescribed by ETSI recommendation EN 302 208. Each frequency band may further be divided into channels a few hundred kHz wide, with the signal nominally centered within a channel in most cases.

There may be additional requirements on the use of these channels. For example, in the United States, a RFID interrogator is usually designed to hop in a random fashion from one channel or frequency to another channel or frequency in a band of frequencies in order to ensure that all the channels are occupied uniformly and avoid interference on one specific part of a band. More generally, frequency hopping is a method of transmitting radio signals by rapidly switching a carrier signal among many frequency channels, using a random sequence known to both the transmitter and the receiver.

More specifically, frequency hopping (also referred to as frequency hopping spread spectrum (FHSS)) is a technique used to prevent RFID interrogators from interfering with one another. In the United States, UHF RFID interrogators operate between 902 and 928 MHz, even though it is said that they operate in the middle of the band at 915 MHz. The RFID interrogators may jump or “hop” randomly or in a programmed sequence residing in a hopping sequence list (“hop list”) to any frequency between 902 MHz and 928 MHz. If the band is wide enough, the chances of two RFID interrogators operating at exactly the same frequency at the same time is small.

Using a slow hop frequency hopping method, sequential frequency hops are utilized by the RFID interrogator 12 in a pseudo-random order, each for a period of less than 400 milliseconds over any 30 second time average. The phrase, “slow hop” refers to an architecture used by modern RFID systems, and particularly by those adhering to the EPCglobal® (i.e. EPCglobal Gen Class 1) standard in which the RFID interrogator 12 at a carrier frequency of about 900 MHz attempts to read many RFID device data bits and many RFID devices during one hop, in less than approximately 400 microseconds.

In the EPCglobal® protocol, the fastest symbol bit rate is approximately 640 KHz. It would be advantageous if an inventory process were faster. Here, an inventory process is a process in which a single RFID interrogator identifies one or more RFID devices that are in its field of view, such as RFID device 14. Most present designs for generating each reader frequency in a hopping sequence use phase locked loop (PLL) designs for frequency synthesizers, which generally take more than 200 microseconds to settle after changing to the next frequency. Some designs have implemented multiple oscillators that are used alternately by switching in one, then the other, back to the first, and so on, to reduce the length of the time gap between frequency hops. This can be complicated and expensive, introduce switching artifacts, and, because of long settling times, does not typically achieve the highest possible frequency hop rates.

A frequency synthesizer using a digital waveform reconstruction with direct memory access (DMA) or Fixed Digital to Analog (FDAC) with a switched set of resistor divider strings for frequency hopping spread spectrum (FHSS) communication systems is much faster than a PLL design, having no settling time and no off-time between frequency hops. The DMA frequency synthesizer enables fast channel acquisition by using a simple memory table look-up technique. The memory look-up technique simplifies the frequency control process and reduces the channel switching time. As a result, the channel efficiency can be improved.

Ultra High Frequency (UHF) signals radiate away from the RFID interrogator antenna as waves. These waves can propagate long distances and interfere with the operation of nearby RFID interrogators (and other radio devices operating in the same band). The antennas usually employed are not terribly directional, and the radiated waves can bounce off objects and people, so that RFID devices outside the “normal” read zone will occasionally be detected.

The RFID interrogator generates a signal (usually voltage or current) on a wire or cable. To convert that signal to an electromagnetic wave, a transmitting antenna is needed. A passive RFID device talks back to the RFID interrogator by changing the amount of the RFID interrogator's signal that is reflected back to the RFID interrogator, or backscattered. In order to detect this backscattered signal 22, the RFID interrogator needs a receiving antenna.

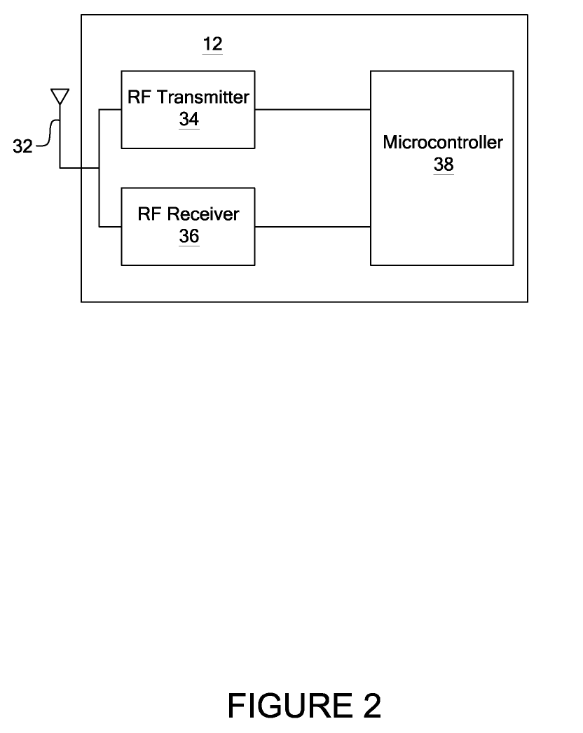

As shown in FIG. 2, the exemplary RFID interrogator 12 includes an antenna 32 coupled to a RF transmitter 34 and a RF receiver 36. The transmitter 34 and receiver 36 are coupled to a microcontroller 38. When interrogating the RFID device 14, digital signal data in accordance with information stored in the microcontroller 38 and information provided by a host application (not shown) is provided, converted into analog signal data, and transmitted to the RFID device 14 via the transmitter 34 and antenna 32. Back-scattered data is then received by the receiver 36 through the antenna 32, converted into digital data by the microcontroller 38 to be further processed, stored in memory, and/or provided to the computer 16.

In previous RFID system designs, as described above, there is a time gap as the RFID interrogator oscillator switches from one frequency to another frequency on a hop list. In those previous RFID systems, it can become problematic to read a tag bit during an off-time gap, the bit having been corrupted, perhaps slowing down a communications session, and perhaps necessitating a restart of an inventory process. Most previous RFID systems require synchronization with the RFID tag reading process with respect to the gap in RFID interrogator RF power. It is advantageous if the RFID system can operate asynchronously without request to frequency hopping gaps.

Previous designs for generating each RFID interrogator frequency in a hopping sequence use PLL designs for synthesizers, which have a gap between hops and generally take more than 200 microseconds to settle after changing to the next frequency. It is advantageous to speed up or eliminate the settling time and gaps, thereby enabling speed up of the frequency hopping process and eliminating the gap's negative effect on reliability of reading a RFID tag response during a gap.

Our design improves communication speed and reliability of RFID systems by using a frequency synthesizer oscillator based on digital waveform reconstruction with direct memory access (DMA) or Fixed Digital to Analog (FDAC) for FHSS backscatter communication systems, such as RFID. Our design enables a RFID system to be simpler, less expensive to manufacture and more robust than PLL systems. In addition, without settling time and off-time between hops, our design can operate asynchronously with a gap-concurrent reflected tag data bit because there is no gap of RF between hops. The DMA frequency synthesizer or FDAC frequency synthesizer provides fast channel acquisition using a simple memory table look-up technique or a switched set of resistor divider strings, respectively. These techniques simplify the frequency control process and reduce the channel switching time. As a result, the channel efficiency can be improved. Our design does not necessitate any redesign of current RFID tags.

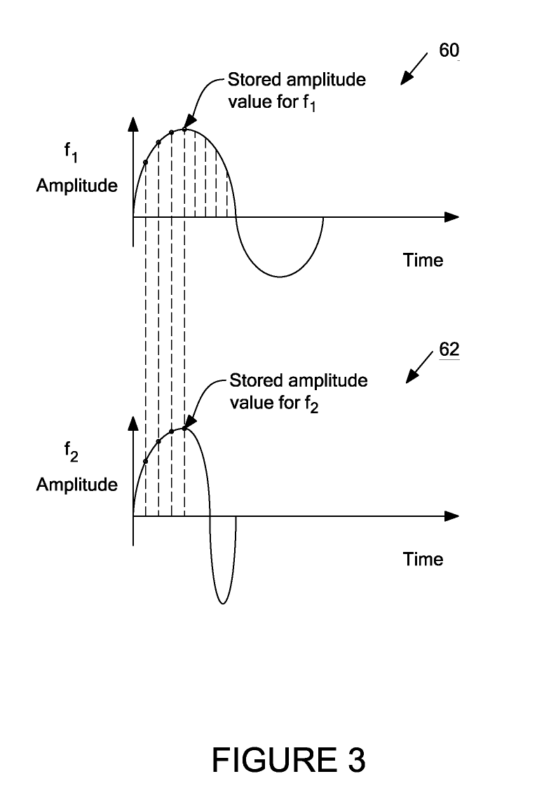

FIG. 3 illustrates two exemplary waveforms 60, 62 of two different frequencies f₁ and f₂ of a frequency hopping sequence when a RFID interrogator includes a frequency synthesizer oscillator based on digital waveform reconstruction with DMA. In an actual hopping sequence list, there would be many additional frequencies, e.g., fifty or so, with sampled amplitudes stored in a RFID interrogator memory for later use in a DMA retrieval scheme, one sample at a time, per a set sample time. The sample time may be set for all frequencies or the sample time may be different for each frequency. The stored waveform may be one cycle that is repeated or may be multiple cycles. The stored waveform may be one cycle repeated at different sample time clock rates so that the sample clock rate determines the frequency of the oscillator.

DMA sample rates for frequency f₁ and frequency f₂ may be the same, as shown, or they may differ. All waveform samples on a hopping sequence list can be stored in one sequence in memory. The switching voltages that produce the samples can be shaped such that there is a separation between switchings or an overlap of one voltage (V) to another voltage or the peaks rounded.

Other hopping sequences or parts of hopping sequences can be stored on different memory locations for later retrieval and reconstruction. Hop sequences can be selected using computer control and or network control.

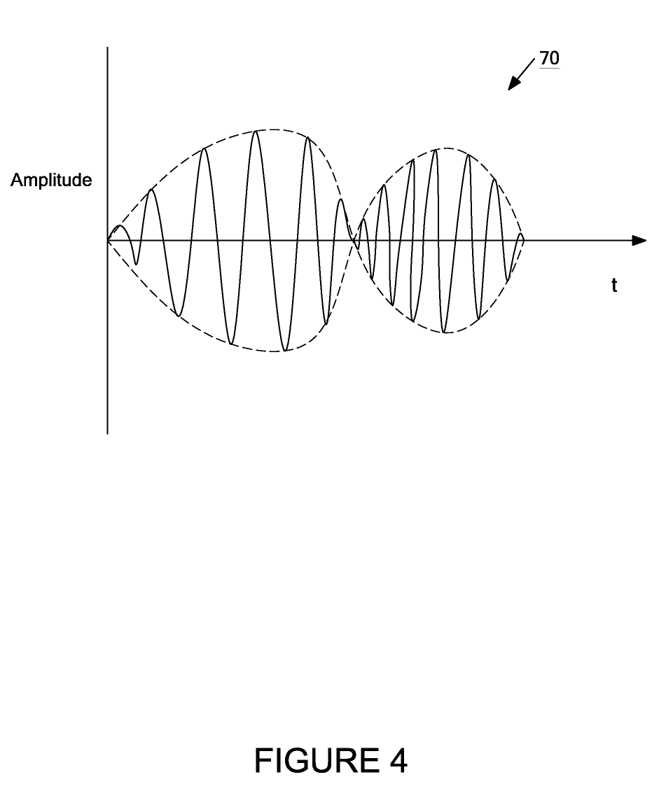

FIG. 4 illustrates a waveform 70 generated by DMA with amplitude envelope modulation. In this example, the envelope tapers the beginning and end of the waveform 70 to improve the sideband generations due to the shape of the envelop itself. One DMA waveform representing the enveloped shape may be used repetitively, may be used as a standard by varying the sample clock to change the frequency presented to the transmitter, or may be constructed to serially represent all the frequencies on the hop list. Other portions of memory may store other hopping sequence waveforms in a similar way. Computer reconstruction may be performed by a variety of control methods, such as, for example, a RISC processor, a DSP processor, a state machine, and so forth, because a standard computer may not be fast enough to perform reconstruction. A standard computer may control the reconstructing components of the design.

In another example, DMA waveforms start at their zero amplitude (0 degrees phase) point.

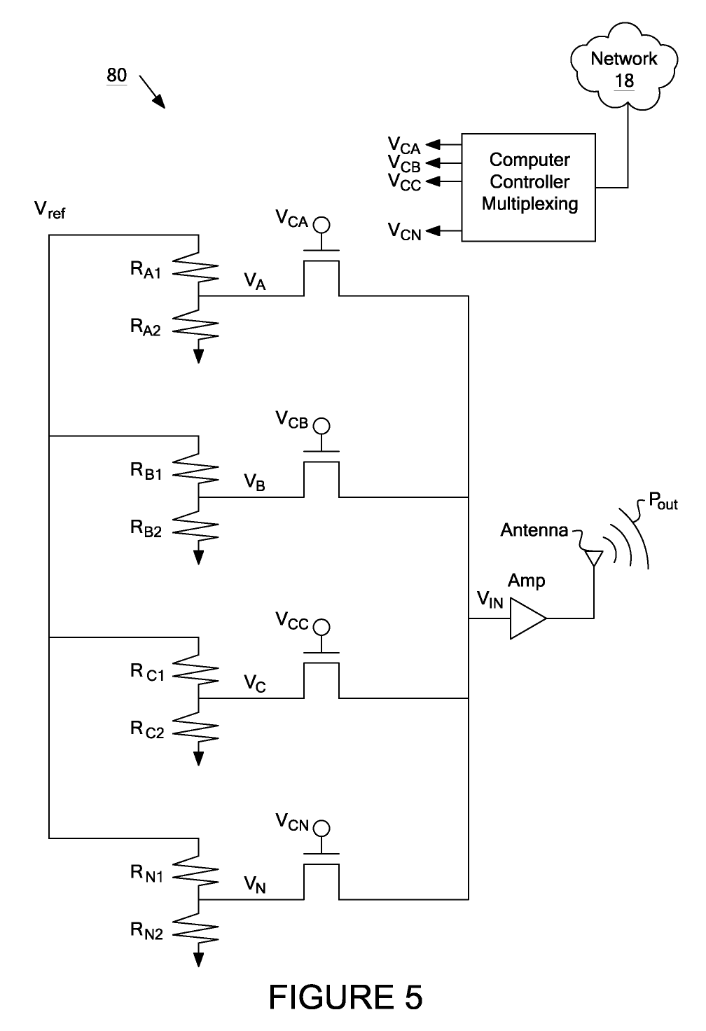

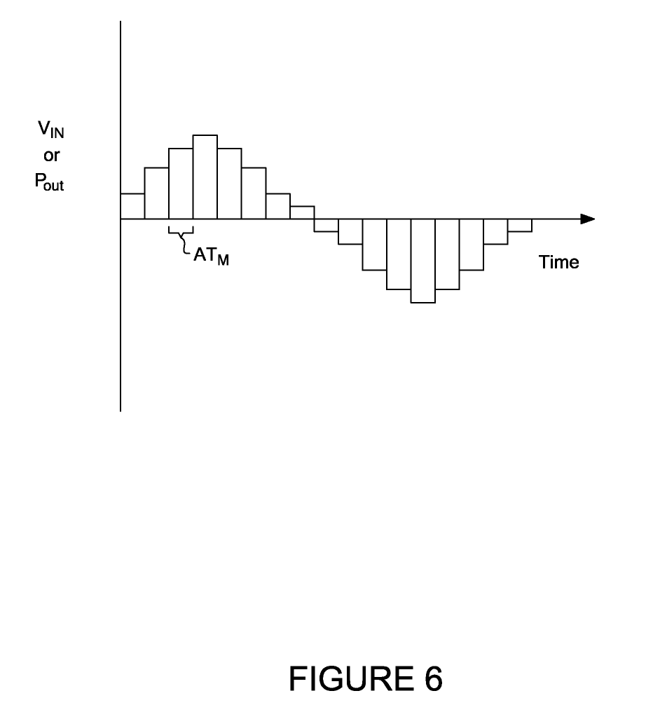

As shown in FIG. 5, an exemplary FDAC implementation 80 includes a group of N resistor dividers. Each resistor divider produces a fixed voltage amplifier input used to reconstruct a RF power output waveform (shown in FIG. 6) under a multiplexing scheme from computer 16. The multiplexer switches at a rate of ΔT_{M}. M can be altered under computer 16 control to produce different frequencies in compliance with frequency hopping rules. The switching voltages, V_{CA} through V_{CN}, can be shaped so there is separation between switchings or an overlap of one voltage to the next voltage or peaks rounded.

The FDAC waveform can be one cycle that is repeated or multiple cycles. The FDAC waveform can be one cycle repeated at different sample time clock rates so that the sample clock rate determines the frequency of the oscillator.

Examples of other types of DACs that can be used for high speed waveform reconstruction include binary weighted DACs, R-2R DACs, Thermometer coded DACs, Segmented DACs, hybrid DACs, and so forth.

FIG. 6 illustrates an exemplary discrete output frequency waveform.

Embodiments of the invention can be implemented in digital electronic circuitry, or digital circuitry combined with analog circuitry or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a logic circuit, a state machine, an ASIC, a computer, or multiple computers. A computer program can be written in any form of programming language, including compiled or interpreted languages, and it can be deployed in any form, including as a stand alone program or as a module, component, logic circuit, state machine, ASIC, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable or fixed processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit) or hard-wired logic control circuitry.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A method comprising:
transmitting from a radio frequency identification (RFID) interrogator a continuous wave un-modulated radio frequency (RF) signal from a frequency synthesizer based on digital waveform reconstruction with Direct Memory Access (DMA), the continuous wave un-modulated RF signal conforming to a fast hop frequency hopping protocol in which each hop of a plurality of hops spans at least one bit but less than the totality of bits to be sent from a single RFID device data in a single communications session.

2. The method of claim 1 further comprising:
sending one or more commands to cause a RFID device to reply; and
transmitting a continuous wave un-modulated RF signal conforming to the fast hop frequency hopping protocol while listening for a RFID device response.

3. The method of claim 2 further comprising:
receiving a RFID device response; and
reporting the RFID device response to a computer coupled to the RFID interrogator.

4. The method of claim 3 in which receiving comprises:
tracking data returned from the RFID device during a hop; and
reconstructing the returned data after RF signal transmission is completed.

5. The method of claim 1 wherein the fast hop frequency hopping protocol comprises:
frequency hops occurring at rates of up to 10 MHz to 50 MHz for operation complying with 900 MHz Part 15 rules; and
frequency hops occurring up to 100 MHz for operation complying with 2.45 GHz Part 15 rules.

6. A method comprising:
transmitting from a radio frequency identification (RFID) interrogator a continuous wave un-modulated radio frequency (RF) signal from a frequency synthesizer based on digital waveform reconstruction with a Digital to Analog Converter (DAC), the continuous wave un-modulated RF signal conforming to a fast hop frequency hopping protocol in which each hop of a plurality of hops spans at least one bit but less than the totality of bits to be sent from a single RFID device data in a single communications session.

7. The method of claim 6 further comprising:
sending one or more commands to cause a RFID device to reply; and
transmitting a continuous wave un-modulated RF signal conforming to the fast hop frequency hopping protocol while listening for a RFID device response.

8. The method of claim 7 further comprising:
receiving a RFID device response; and
reporting the RFID device response to a computer coupled to the RFID interrogator.

9. The method of claim 8 in which receiving comprises:
tracking data returned from the RFID device during a hop; and
reconstructing the returned data after RF signal transmission is completed.

10. The method of claim 6 wherein the fast hop frequency hopping protocol comprises:
frequency hops occurring at rates of up to 10 MHz to 50 MHz for operation complying with 900 MHz Part 15 rules; and
frequency hops occurring up to 100 MHz for operation complying with 2.45 GHz Part 15 rules.

11. The method of claim 6 wherein the DAC is a Fixed DAC, a Binary Weighed DAC, a R-2R DAC, a Thermometer coded DAC, a Segmented DAC or a Hybrid DAC.

12. A radio frequency identification (RFID) interrogator comprising:
a microcontroller coupled to a radio frequency (RF) transmitter and a RF receiver;
an antenna coupled to the RF transmitter and RF receiver; and
the microcontroller causing the RF transmitter to transmit a continuous wave un-modulated radio frequency (RF) signal from a frequency synthesizer based on digital waveform reconstruction with Direct Memory Access (DMA), the continuous wave un-modulated RF signal conforming to a fast hop frequency hopping protocol in which each hop of a plurality of hops spans at least one bit but less than the totality of bits to be sent from a single RFID device data in a single communications session.

13. The RFID interrogator of claim 12 wherein the fast hop frequency hopping protocol comprises:
frequency hops occurring at rates of up to 10 MHz to 50 MHz for operation complying with 900 MHz Part 15 rules; and
frequency hops occurring up to 100 MHz for operation complying with 2.45 GHz Part 15 rules.

14. A radio frequency identification (RFID) interrogator comprising:
a microcontroller coupled to a radio frequency (RF) transmitter and a RF receiver;
an antenna coupled to the RF transmitter and RF receiver; and
the microcontroller causing the RF transmitter to transmit a continuous wave un-modulated radio frequency (RF) signal from a frequency synthesizer based on digital waveform reconstruction with a Digital to Analog Converter (DAC), the continuous wave un-modulated RF signal conforming to a fast hop frequency hopping protocol in which each hop of a plurality of hops spans at least one bit but less than the totality of bits to be sent from a single RFID device data in a single communications session.

15. The RFID interrogator of claim 14 wherein the DAC is a Fixed DAC, a Binary Weighed DAC, a R-2R DAC, a Thermometer coded DAC, a Segmented DAC or a Hybrid DAC.

16. The RFID interrogator of claim 14 wherein the fast hop frequency hopping protocol comprises:
frequency hops occurring at rates of up to 10 MHz to 50 MHz for operation complying with 900 MHz Part 15 rules; and
frequency hops occurring up to 100 MHz for operation complying with 2.45 GHz Part 15 rules.
